(19) United States
(12) Patent Application Publication
(10) Pub. No.: US 2011/0063335 A1
(43) Pub. Date: Mar. 17, 2011

(54) COLOR-FILTERLESS LIQUID CRYSTAL DISPLAY DEVICE AND DISPLAYING METHOD THEREOF

(75) Inventors: Tsung-I Wang, Kuei-Shan Hsiang (TW); Chin-Chun Wu, Kuei-Shan Hsiang (TW); Chia-Liang Yang, Kuei-Shan Hsiang (TW); Yao-Chiu Chang, Kuei-Shan Hsiang (TW)

(73) Assignee: DYNASCAN TECHNOLOGY CORP., Kuei-Shan Hsiang (TW)

(21) Appl. No.: 12/873,318

(22) Filed: Sep. 1, 2010

(30) Foreign Application Priority Data
Sep. 11, 2009 (TW) 98130746

(51) Int. Cl. G09G 5/10; G09G 3/36

(52) U.S. Cl. 345/690; 345/88

(57) ABSTRACT

The invention relates to a color-filterless liquid crystal display device and a displaying method of the display device. The backlight module of the display device is partitioned into dynamic brightness adjustment sections adapted for being controlled by the local area dimming control technique. The liquid crystal display module of the display device is partitioned into display sections for being subjected to scanning. The sub-frame image data are adjusted reversely to that done by the local area dimming control technique, before being provided to the display sections by scanning. After the transmissivity of the respective display sections is changed, the LEDs located in the dynamic brightness adjustment sections and corresponding to the sub-frames are lighted up by local area dimming control signals capable of compensating for the adjustment.

### FIELD OF THE INVENTION

The present invention relates to a color-filterless liquid crystal display device and a displaying method thereof. More particularly, the invention relates to a color-filterless liquid crystal display device, whose liquid crystal display module is enabled to display an image by being scanned section-wise and whose backlight module is adjusted dynamically in terms of brightness level, as well as a displaying method thereof.

### DESCRIPTION OF THE RELATED ART

As the technology of LED backlight is getting mature for industrial applications, LED lamps are increasingly adopted in place of traditional cold cathode fluorescent lamps (CCFLs) as a backlight source for liquid crystal display devices, due to their extensive lifespan and potential to reduce power consumption, as well as the advantageous theoretical color gamut presented by the RGB LED backlight system which is presumably broad enough to provide more vivid color diversion. Moreover, taking advantage of the RGB color sequential scanning technique, the display devices provided with the RGB LED backlight system need not be equipped with color filters for color mixing and, thus, will not suffer from the energy loss caused thereby. The sparring of color filters is also beneficial to the cost reduction of display devices.

However, in a color-filterless LCD device, the RGB light sources need be lighted up in a sequential order and the liquid crystal module mounted in front of the backlight module is required to sequentially display RGB sub-frames in a color-by-color manner. As a result, the response time thereof is required to be 3-times fast than traditional LCD devices. In the case where 60 frames are displayed per second, the sub-frame time for each primary color will only be 1/180 second, approximately 5.5 ms. For illustrative purpose, an HDTV with a resolution of 1920*1080 is illustrated in FIG. 1 to have a liquid crystal module partitioned into, for example, 18 zones. Each zone is referred to as a display section hereafter, with each display section encompassing 60 horizontal scan lines.

For illustrative purpose, the X coordinate in FIGS. 2 and 3 represents time, while the Y coordinates shown in the upper panels denote the brightness levels of the lighted LEDs in the backlight module and the Y coordinates shown in the lower panels indicate the transmissivity of the liquid crystal module which varies according to the image data written thereinto. As shown in FIG. 2, during the sub-frame time of 5.5 ms, the image data should be provided to a total of 1080 scan lines in the liquid crystal module to effect a horizontal scanning. Given that the response time of a conventional thin film transistor (TFT) ranges between about 2 μs and 10 μs, the overall period of time required for horizontally scanning an entire picture is about 2.2 ms. The respective liquid crystal pixels are subsequently driven to change their transmissivities according to the image data. The respective response time for each of the liquid crystal pixels is about 3 ms as indicated by the solid lines in the lower panels.

Therefore, the receipt of image data by the pixels of the respective display sections and the changing of transmissivity have already taken 5.2 ms from the sub-frame time for each primary color. As a consequence, it leaves only 0.3 ms for lighting up the corresponding LEDs in the backlight module. As compared to the entire frame time of 5.5 ms, the LED lighting duty takes only 0.3 ms/5.5 ms [symbol] 5%. In a color-filterless LCD device of this type, only a small proportion of time over the time coordinate will serve to LED lighting, suggesting a low efficiency of utilization of LEDs.

In order to address this problem, a multi-sectional scanning technique is adopted to break the ideas that an image frame should be processed in a synchronized manner, pixels should be displayed at the same time and the backlight module should be turned on in a synchronized manner over the time coordinate. As shown in FIG. 3, a single unit ΔT in the time coordinate is equal to 0.3 ms, with the sub-frame time for each sub-frame being equal to 18*ΔT. As further shown by the dashed lines in the lower panel of FIG. 3, the pulse periods represent that the respective display sections are receiving image data for respective colors and each of the 60 scan lines in the first display section (which is denoted as 1 in the lower panel of FIG. 3) corresponds to 1920 liquid crystal pixels. Assuming that the image signals are provided in the form from 0 to 255 (namely, in the form of 8-bit image signals), the respective liquid crystal pixels are enabled to present 256 levels of transmissivity, in which an image signal of 255 represents the corresponding pixel being in a fully opened state where the backlight completely transmits through liquid crystal molecules to achieve the brightest condition, while an image signal of 0 represents the corresponding pixel being in a fully closed state and place the liquid crystal molecules in the darkest condition.

The horizontal scanning is started at a time point t=0, at which the image data of red sub-frame start to be provided to the respective pixels in the first display section. Since the scanning time for the 1-60 horizontal scan lines in the first display section takes, for example, 0.3 ms, the providing of image data to the first display section is completed at t=ΔT=0.3 ms and the second display section starts to be subjected to the horizontal scanning afterwards. The third display section is subjected to scanning at t=2 ΔT . . . until completion of providing data to the pixels at 18 ΔT. The image data of green sub-frame are provided afterwards, and the image data of blue sub-frame start to be provided at t=36 ΔT.

The liquid crystal pixels in the respective display sections, after receiving image data, will wait about 3.0 ms [symbol] 10 ΔT until liquid crystal molecules completely respond. In theory, the liquid crystal pixels in the first display section complete the change in transmissivity at t=11 ΔT=3.3 ms. At this moment, the corresponding red light LEDs in the backlight module to the first display section are turned on, and the sub-frame time for the first display section remains to have about 5.4 ms−0.3 ms−3.0 ms=2.1 ms [symbol] 7 ΔT. The sub-frame period for the red sub-frame is completed at t=18 ΔT [symbol] 5.4 ms, the corresponding backlight to the first display section is turned off. Similarly, the corresponding red light LEDs to the second display section are turned on at t=12 ΔT=3.6 ms and subsequently turned off at t=19 ΔT [symbol] 5.7 ms. The activation and deactivation of the LEDs corresponding to the third display section are performed after the activation and deactivation of the LEDs corresponding to the second display section, respectively, by a time delay of a ΔT, and the rest can be reasoned out by analogy.

Since the timings for the respective display sections to display a sub-frame are discrete from one another, the entire frame is in fact not displayed in a synchronized manner. Therefore, the timings for the respective display sections to turn on and off the corresponding backlight can be independently controlled according to the schedules of their own, and a frame can be displayed in all of the available time except for the response time of liquid crystal molecules and the time needed for receiving image data. As a result, the backlight lighting duty is elevated to 2.2 ms/5.5 ms [symbol] 40%, a significant improvement over the lighting duty of 5% obtained by using the traditional non-scanning-type backlight described above. It is apparent that independently controlled LED backlight zones, each being composed of red, green and blue LEDs, should be provided in the backlight module in a manner corresponding to the respective display sections.

There is, however, a significant limitation to the technique described above in that the response time of liquid crystal molecules must be extremely rapid. Otherwise, the transmissivity that need be rapidly resumed to its original state after the corresponding primary color is presented may fail to be completely resumed within a sub-frame period and, as shown in FIG. 4, the next sub-frame periods for different primary colors would start at, for example, 5.4 ms, 10.8 ms and 16.2 ms. After another 0.3 ms for receiving image data, the liquid crystal pixel would not be activated from its predetermined non-transmissive state, resulting in an improper color mixing of a primary color with the next presented primary color.

Extensive investigations show that the response time of liquid crystal molecules normally varies along different types of color level conversion. Although the so-called over-drive technique is recently used to address such a problem, it is not able to accelerate the response time of liquid crystal molecules when the liquid crystal molecules are being resumed to their original state. For example, in the case where a liquid crystal pixel is resumed from the brightest state to the darkest state, the time that the procedure may take is several times greater than an average response time. When it takes a relatively long time to convert a certain color level to another, the liquid crystal molecules may still not be placed in a fully closed state but the backlight may have started to emanate light of the next sequential primary color. As a result, a sub-frame of a certain primary color may be improperly combined with the next sequential sub-frame of a different primary color, causing a viewer to perceive a shift in color appearance and a reduction in color saturation due to persistence of vision.

For better understanding of the sequential relationship among the backlight module, the liquid crystal module and the entire display device in terms of color presentation, the lighting up of LEDs in the backlight module, the transmissivity of the liquid crystal module and the color performance of the entire display device are plotted against time as shown in the upper, middle and lower panels of FIGS. 5, 8-10 and 15-17, respectively.

Now referring to FIG. 5, in the case where the first display section is rendered to present pure red color, during the red sub-frame period starting from t=1 to t=11 ΔT, an image data of R=255 is provided and liquid crystal molecules are converted from the OFF state into the ON state. After a response time of about 10 ΔT=3 ms, the liquid crystal molecules are driven to have the highest transmissivity to light and the state is maintained until t=18 ΔT=5.4 ms. As shown in the upper panel of FIG. 5, a red light LED is lighted up from t=11 ΔT to t=18 ΔT, rendering the first display section of the display device to present red color.

The green sub-frame period starts at t=18 ΔT=5.4 ms. After a period of scanning time ΔT for providing image data, the first display section is provided with an image data of G=0 at t=19 ΔT, and the liquid crystal molecules start to be converted from the fully opened state (namely, the brightest state) to the fully closed state (namely, the darkest state) as shown in the middle panel. If the liquid crystal molecules respond rapidly and take 10 ΔT [symbol] 3.0 ms (namely, from t=19 ΔT to 29 ΔT) to be completely converted to the OFF state, there would not be an improper mixing of colors from t=29 ΔT to 36 ΔT during the period which a corresponding green light LED mounted in the backlight module is lighted up.

However, the actual meaning of the response time of a liquid crystal molecule usually refers to an average response time to different types of grayscale conversion. The conversion carried out between two close levels of transmissivity takes only a short time. In contrast, the slowest response time may occur when a liquid crystal molecule is switched from a fully dark state to a fully bright state, or vise versa. A rise-time (tᵣ) is normally defined as a time required for the transmissivity to rise from 10% to 90% of the brightest level, whereas a fall-time (t_{f}) is defined to be a time required for the transmissivity to decrease from 90% to 10% of the brightest level. In this case, even if the liquid crystal molecule has an average response time of 3 ms, the fall time may last up to 10 ms when the grayscale value is converted from L=255 to L=0. It takes 10 ms (approximately 30 ΔT) for the liquid crystal molecule to be completely converted from the ON state to the OFF state. This suggests that the conversion, if starting from the time point t=19 ΔT, is not completed until t=48 ΔT, and that the conversion is much less than completed at t=29 ΔT where the green sub-frame period starts.

Under the condition that the liquid crystal molecule is still not placed in the fully closed state, the green backlight corresponding to the first display section is turned on at t=29 ΔT and then turned off at t=36 ΔT. As shown in the lower panel of FIG. 5, the green backlight is mixed with the red color presented by the previous sequential sub-frame until t=36 ΔT. The amount of green light mixed with the red light will gradually decrease as the liquid crystal molecule is gradually converted to the fully closed state. However, as shown in FIG. 5, the amount of green light mixed with the red light still has an intensity of 30% relative to the red light intensity, causing a significant deterioration of the red color quality in the first display section due to persistence of vision.

A corresponding blue light LED is subsequently turned on at t=47 ΔT, where the liquid crystal molecule has responded for about 28 ΔT=8.4 ms and has almost been in a fully closed state. As such, the amount of blue light mixed with the red light is relatively small and is normally at a level that can be ignored. In other words, since the transmissivity of a liquid crystal molecule cannot be converted from a maximum value to a minimum value, the frame presented by the display device, as shown in the lower panel of FIG. 5, would be improperly mixed with the green light that is not supposed to be presented, when the green light LED is turned on as shown in the upper panel of FIG. 5.

By the same token, in the case where the first display section is rendered to present pure green color or pure blue color, the presented frames would be interfered with blue color and red color, respectively. Therefore, although the gamut available to the backlight module is shown by the triangle defined by the three black dots in FIG. 6, where the black dots represent the three primary colors for this gamut, the actual gamut of a conventional color-filterless display device provided with an RGB-color scanning-type LED backlight is shifted due to the improper mixing of red color with green color, green color with blue color and blue color with red color caused by the slow response time of liquid crystal molecules. For example, the chromaticity of a red-light LED, which is of a red chromaticity coordinate of R=(0.7, 0.3), may shift to R′=(0.6, 0.4) due to an improper mixing with green color. Similarly, the original chromaticity G=(0.2, 0.75) of a green-light LED may shift to G′=(0.3, 0.6), and the original chromaticity B=(0.14, 0.05) of a blue-light LED may shift to B′=(0.25, 0.15) due to mixing with red color. The actual gamut is represented by the smaller triangle shown in FIG. 6, indicating that after the chromaticity shift, the gamut is much narrower than expected and the resultant color appearance is less vivid than required.

As further shown in FIG. 7, a frame 10 presented by a display device is for the sake of illustration partitioned into 6 zones designated as zones 11, 12, 13 . . . 16, respectively, wherein zone 11 is directed to sky with blue color, zone is directed to sunshine with red color, zones 14 and 15 are directed to mountain green, and zones 13 and 16 are directed to a building with grey color. As shown in FIGS. 8 and 9, the blue and red color appearances of zones 11 and 12 are undesirably mixed with red color and green color, respectively. Only the grey color shown in zone 13 is not adversely affected as shown in FIG. 10.

Efforts have been made to improve the response time of liquid crystal molecules. For example, the so-called OCB (Optical Compensated Birefringence) liquid crystal may achieve a response time of 2-3 ms. However, such a technique has not been widely adopted in large-size LCD televisions. Meanwhile, the frame refresh rate of televisions is advanced from 60 frames per second to 120 frames per second, suggesting that the response time of liquid crystal molecules should be more rapid than ever. As a consequence, the color-filterless display devices of this type have not yet been commercialized successfully.

### SUMMARY OF THE INVENTION

Accordingly, a purpose of the present invention is to provide a color-filterless liquid crystal display device, which may significantly reduce the improper mixing of colors and therefore present a broad gamut and an increased color diversion with close resemblance to those derived from the RGB LEDs mounted in the backlight module.

Another purpose of the invention is to provide a practicable color-filterless liquid crystal display device capable of practically avoiding the emitted light from being absorbed by a color filter and converted to useless heat energy, so as to meet the global trend towards energy saving and carbon emission reduction.

It is still another purpose of the invention to provide a color-filterless liquid crystal display device capable of reducing light leak under a lower brightness grayscale level, so as to achieve contrast enhancement of images.

It is still another purpose of the invention to provide a displaying method, which is effective to significantly reduce the improper mixing of colors and therefore allow a display device to present a broad gamut and an increased color diversion with close resemblance to those derived from the RGB LEDs mounted in the backlight module.

It is still another purpose of the invention to provide a displaying method for use in a color-filterless liquid crystal display device as a means for energy saving.

The present invention therefore provides a color-filterless liquid crystal display device for displaying a frame within a predetermined display period and the frame is partitioned into image data of at least three color sub-frames. The invented display device comprises:

(a) a liquid crystal display module including at least one scan zone, the at least one scan zone being partitioned into a plurality of display sections, wherein each of the display sections includes a plurality of pixels;

(b) a backlight module partitioned into a plurality of dynamic brightness adjustment sections in such a manner that every one of the display sections is arranged to correspond to at least one of the dynamic brightness adjustment sections, wherein each of the dynamic brightness adjustment sections comprises light emitting diodes of at least three colors, with each of the colors being presented by at least one of the light emitting diodes, and wherein the light emitting diodes are lighted up sequentially in a color-by-color manner; and

(c) a control module for adjusting the image data of the sub-frames according to the dynamic brightness adjustment sections to obtain adjusted image data of the sub-frames, and for providing the adjusted image data of one of the sub-frames to the corresponding pixels located in one of the display sections, so that the pixels are driven to undergo a change in transmissivity within a transition period according to the adjusted image data, and for driving, according to the transition period, at least one of the light-emitting diodes of at least three colors, which is located in the dynamic brightness adjustment section corresponding to the display section and is capable of emitting light with a color corresponding to the color of the sub-frame, to emit light at the compensated brightness level for the adjustment.

Since the display sections are arranged corresponding to the dynamic brightness adjustment sections, the transmissivity of the liquid crystals located in a given display section may be adjusted with reference to a theoretical brightness level of a sub-frame image data to be presented by the dynamic brightness adjustment section corresponding to the display section, and the brightness level of the LED located in the dynamic brightness adjustment section and capable of emitting light with a color corresponding to the color of the sub-frame is then compensatively changed according to the adjustment.

By way of using the field-sequential-color technique to scan the display sections and simultaneously using the local area dimming control technique to control the brightness of the backlight module, the LEDs mounted in the backlight module will not emit a large quantity of light when unnecessary, whereby the unwanted color components are eliminated from the light leaking from the liquid crystal display module. A color-filterless liquid crystal display device can be commercialized successfully according to the invention, so as to realize the idea of not using a color filter in the display device and also the idea of saving energy by increasing the utilization efficiency of light emitted from the backlight module. Moreover, since the unwanted color components are significantly reduced, the image displayed by the invented display device has a broad gamut and an increased color diversion with close resemblance to those derived from the RGB LEDs mounted in the backlight module. The invented display device may therefore satisfy the viewer's needs and has an increased product value.

The present invention further provides a displaying method of a color-filterless liquid crystal display device. The liquid crystal display device is used for displaying a frame within a predetermined display period and the frame is partitioned into image data of at least three color sub-frames. The display device comprises a liquid crystal display module including at least one scan zone, and the at least one scan zone is partitioned into a plurality of display sections. The display device also comprises a backlight module partitioned into a plurality of dynamic brightness adjustment sections in such a manner that every one of the display sections is arranged to correspond to at least one of the dynamic brightness adjustment sections. Each of the display sections includes a plurality of pixels, and each of the dynamic brightness adjustment sections comprises light emitting diodes of at least three colors, with each of the colors being presented by at least one of the light emitting diodes. The light emitting diodes are lighted up sequentially in a color-by-color manner. The invented method comprises the steps of:

a) adjusting the image data of the respective color sub-frames according to the dynamic brightness adjustment sections to obtain adjusted image data of the sub-frames;

b) providing the adjusted image data of the sub-frames to every one of the corresponding pixels located in one of the display sections of the at least one scan zone, and driving the pixels to undergo a change in transmissivity within a transition period according to the adjusted image data; and

c) according to the transition period, driving at least one of the light-emitting diodes of at least three colors, which is located in the dynamic brightness adjustment section corresponding to the display section and is capable of emitting light with a color corresponding to the color of the sub-frame, to emit light at the compensated brightness level for the adjustment.

### BRIEF DESCRIPTION OF THE DRAWINGS

The above and other objects, features and effects of the invention will become apparent with reference to the following description of the preferred embodiments taken in conjunction with the accompanying drawings, in which:

FIG. 1 is a schematic diagram illustrating display sections of a conventional liquid crystal module;

FIG. 2 is a schematic sequence diagram of the displaying conditions of a conventional color-filterless liquid crystal display device, illustrating the time sequential relationship between the activities of the backlight module and the liquid crystal display module, and elucidating the reason that results in insufficient brightness of images;

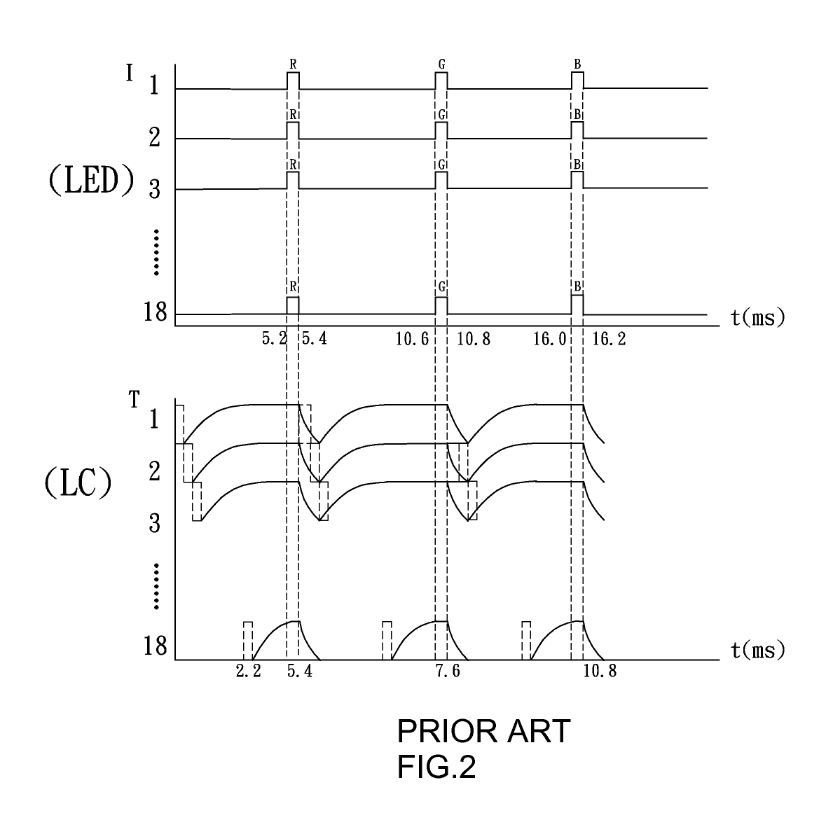

FIG. 3 is a schematic sequence diagram of the displaying conditions of a conventional color-filterless liquid crystal display device whose liquid crystal display module is enabled to display an image by being scanned section-wise, illustrating the time sequential relationship between the activities of the backlight module and the liquid crystal display module;

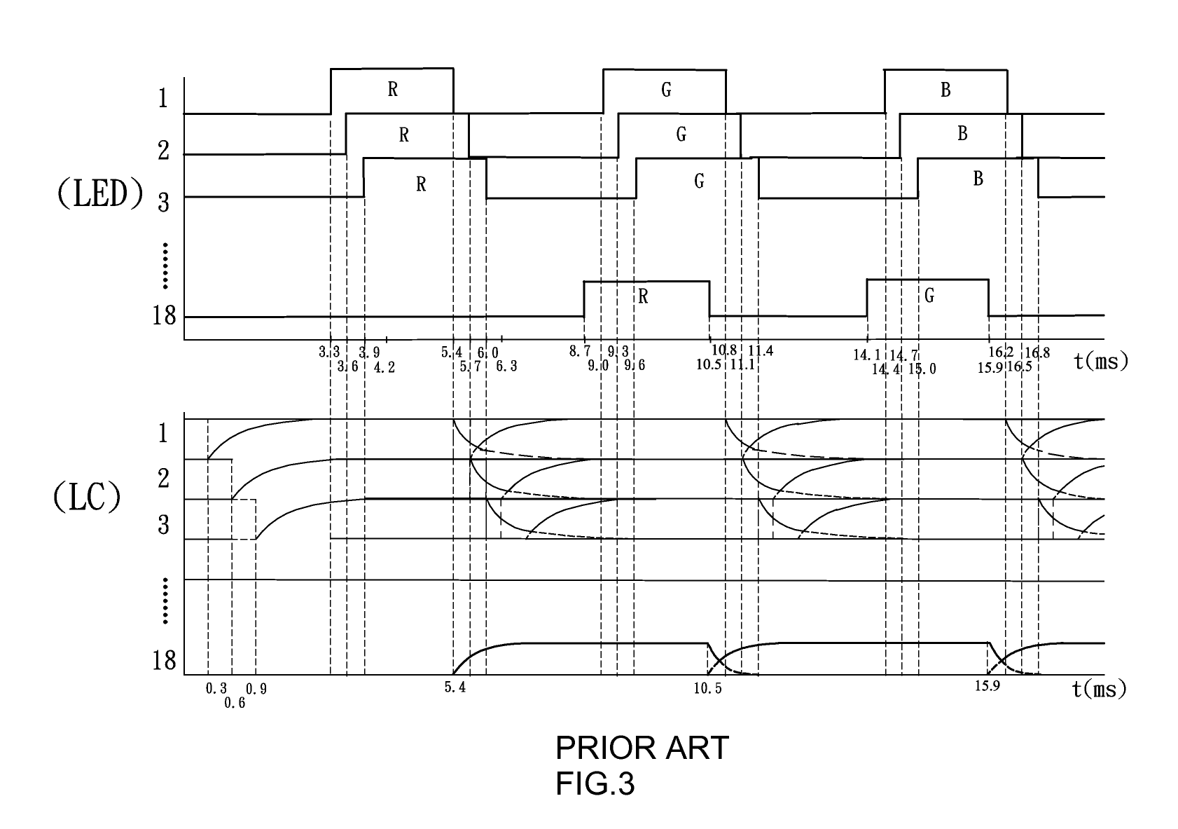

FIG. 4 is a schematic sequence diagram illustrating the activities of the liquid crystal display module in the display device of FIG. 3 and elucidating how an image is to be displayed by sequentially presenting different colors;

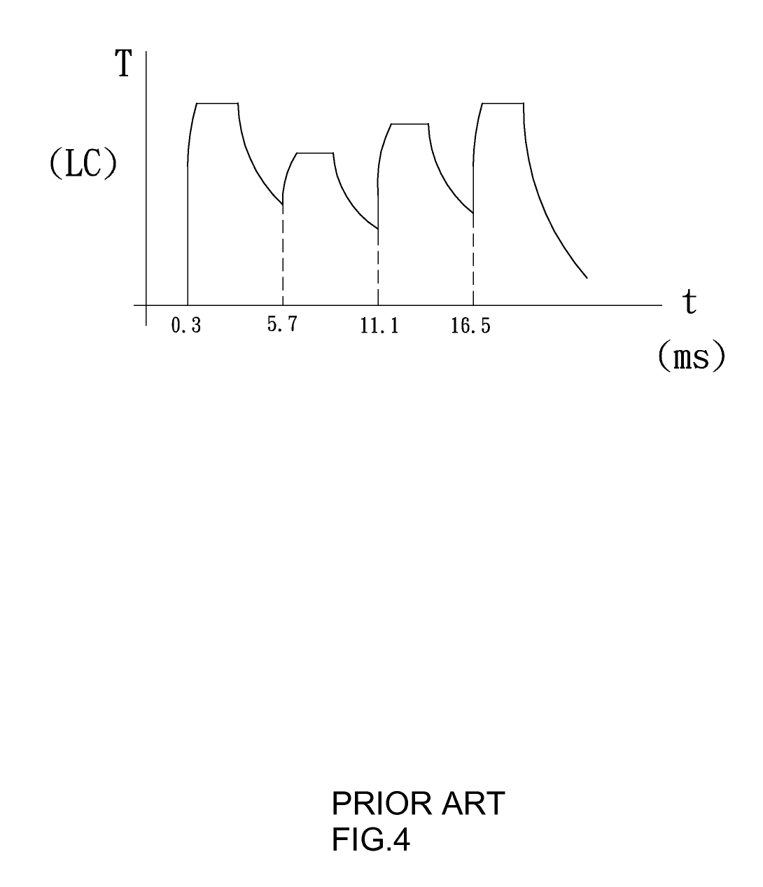

FIG. 5 is a schematic sequence diagram illustrating the activities of the display device of FIG. 3 and elucidating how the light leak problem occurs;

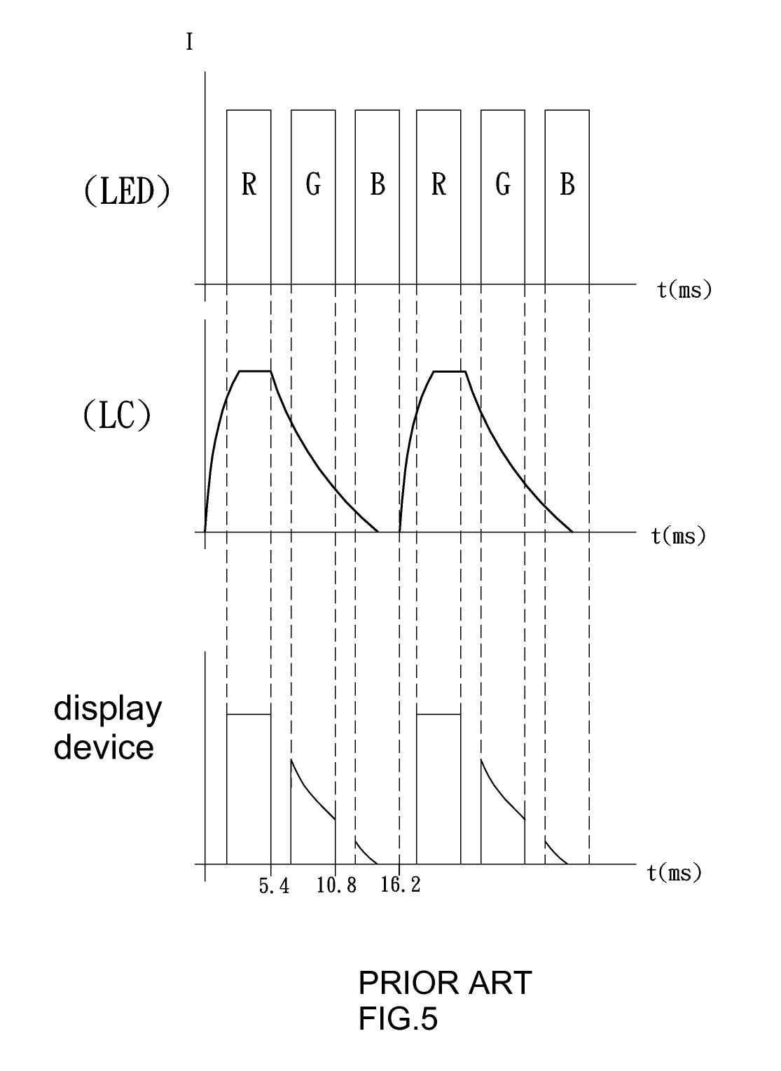

FIG. 6 is a CIE chromaticity diagram that can be perceived by the human eye, showing that the light leak may result in a narrower gamut of colors;

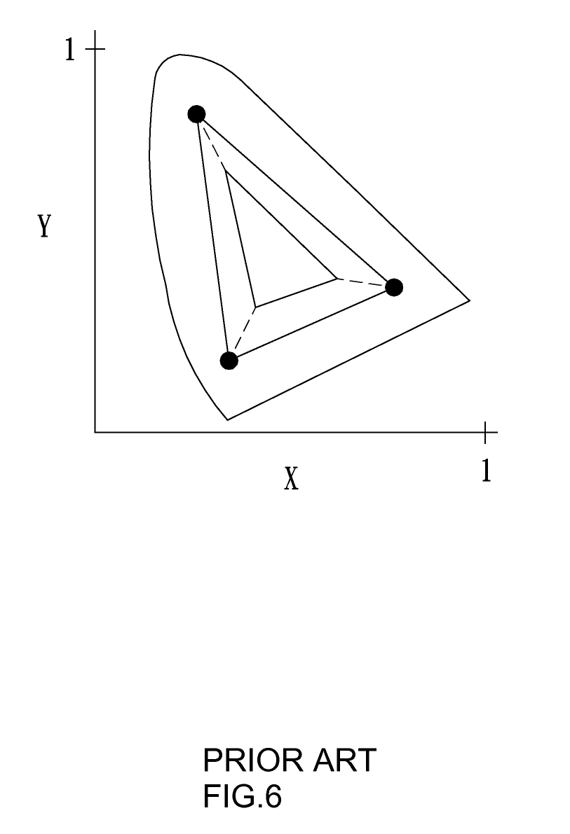

FIG. 7 is a schematic diagram of a displayed frame;

FIG. 8 is a schematic sequence diagram illustrating the time sequential relationship between the activities of the backlight LEDs corresponding to zone 11 of the frame shown in FIG. 7 and the corresponding liquid crystals;

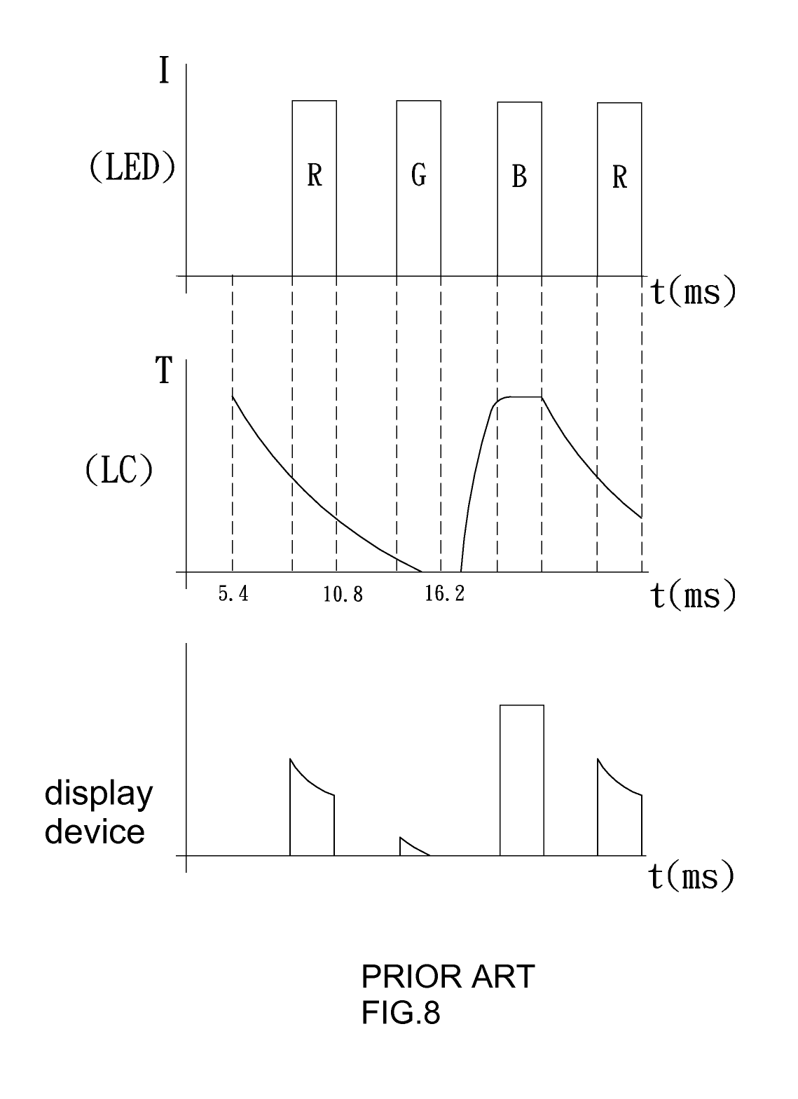

FIG. 9 is a schematic sequence diagram illustrating the time sequential relationship between the activities of the backlight LEDs corresponding to zone 12 of the frame shown in FIG. 7 and the corresponding liquid crystals;

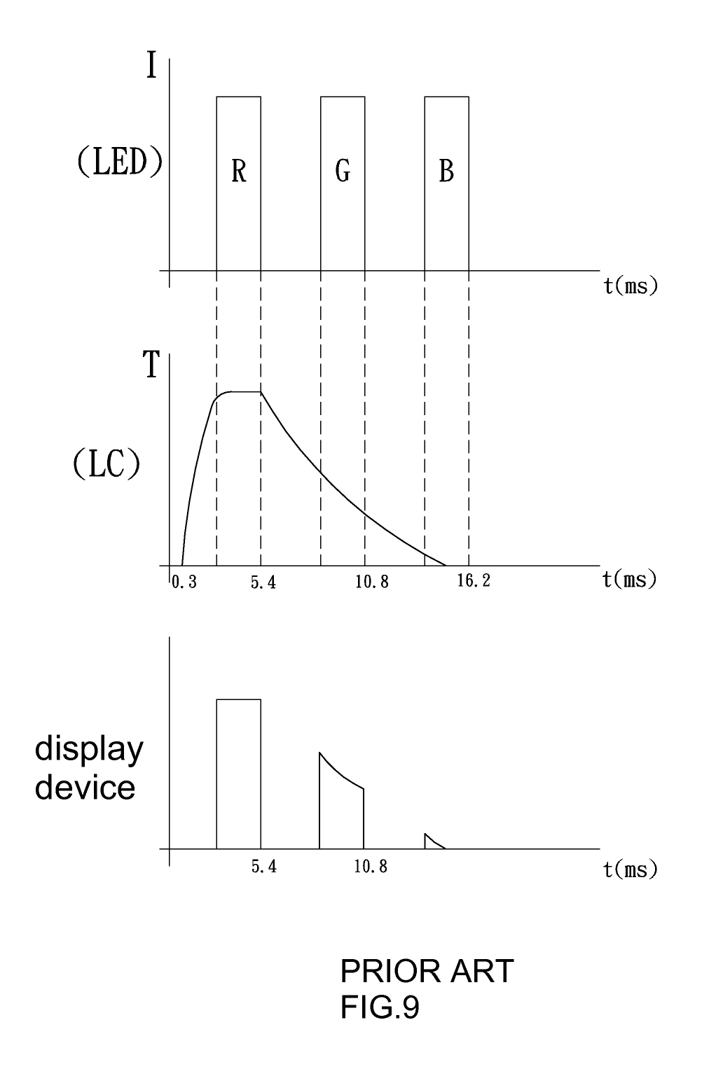

FIG. 10 is a schematic sequence diagram illustrating the time sequential relationship between the activities of the backlight LEDs corresponding to zone 13 of the frame shown in FIG. 7 and the corresponding liquid crystals;

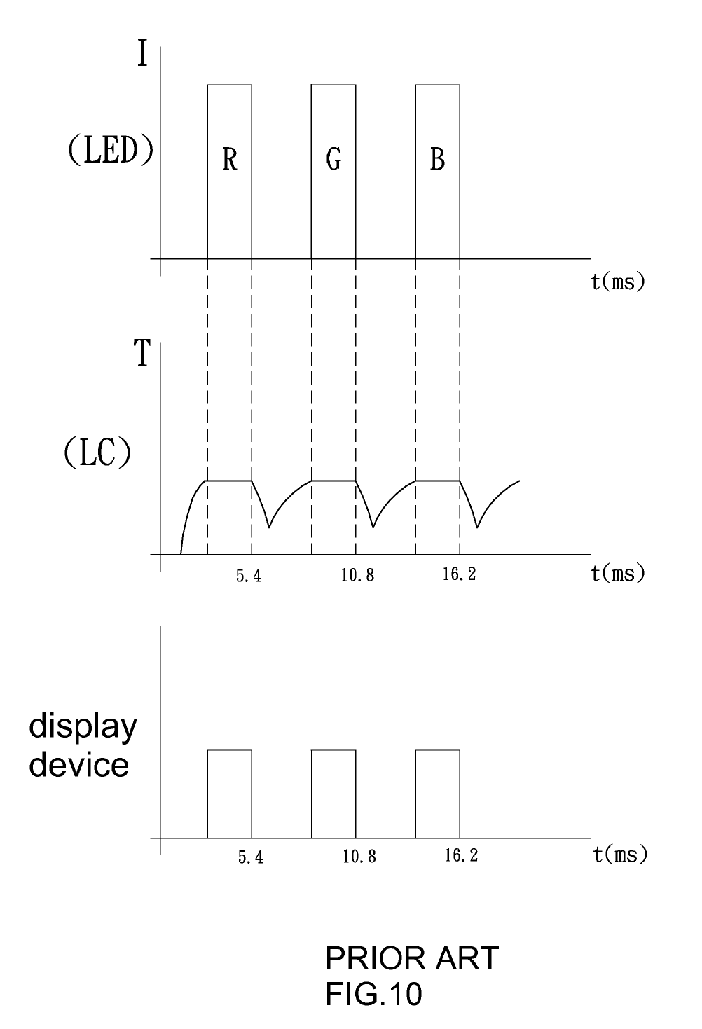

FIG. 11 is a schematic diagram illustrating a color-filterless liquid crystal display device according to the first preferred embodiment of the invention;

FIG. 12 is a block diagram illustrating the relationship among the structural elements of the display device shown in FIG. 11;

FIG. 13 shows a flowchart of the displaying method according to the embodiment of FIG. 11;

FIG. 14 is a schematic diagram illustrating a frame-partitioning module for partitioning an original image data of a frame into image data of sub-frames of respective colors;

FIG. 15 is a schematic sequence diagram illustrating the time sequential relationship between the activities of the backlight LEDs corresponding to the dynamic brightness adjustment sections 3011 and 3012 and the corresponding liquid crystals, when the frame of FIG. 7 is presented by the display device of FIG. 11;

FIG. 16 is a schematic sequence diagram illustrating the time sequential relationship between the activities of the backlight LEDs corresponding to the dynamic brightness adjustment section 3013 and the corresponding liquid crystals, when the frame of FIG. 7 is presented by the display device of FIG. 11;

FIG. 17 is a schematic sequence diagram illustrating the time sequential relationship between the activities of the backlight LEDs corresponding to the dynamic brightness adjustment section 3052 and a liquid crystal pixel in the display section, when the frame of FIG. 7 is presented by the display device of FIG. 11; and

FIG. 18 is a schematic sequence diagram illustrating the time sequential relationship between the activities of structural elements in a color-filterless liquid crystal display device according to the second preferred embodiment of the invention.

### DETAILED DESCRIPTION OF THE INVENTION

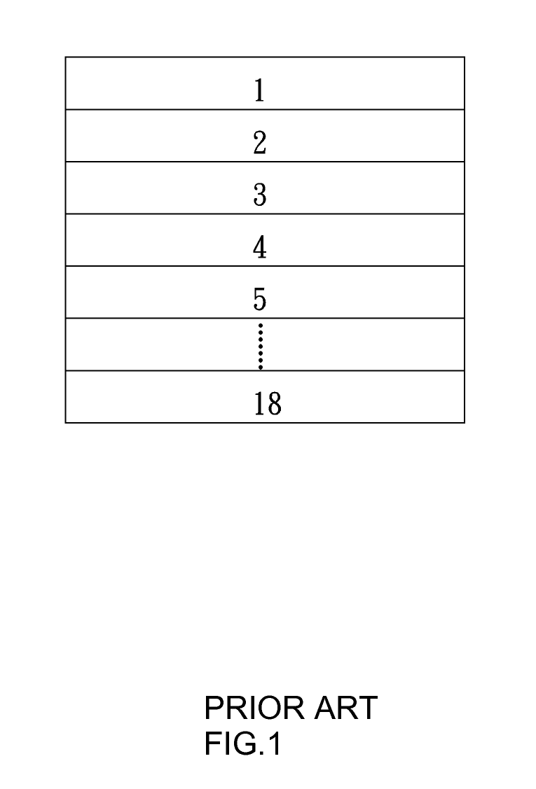

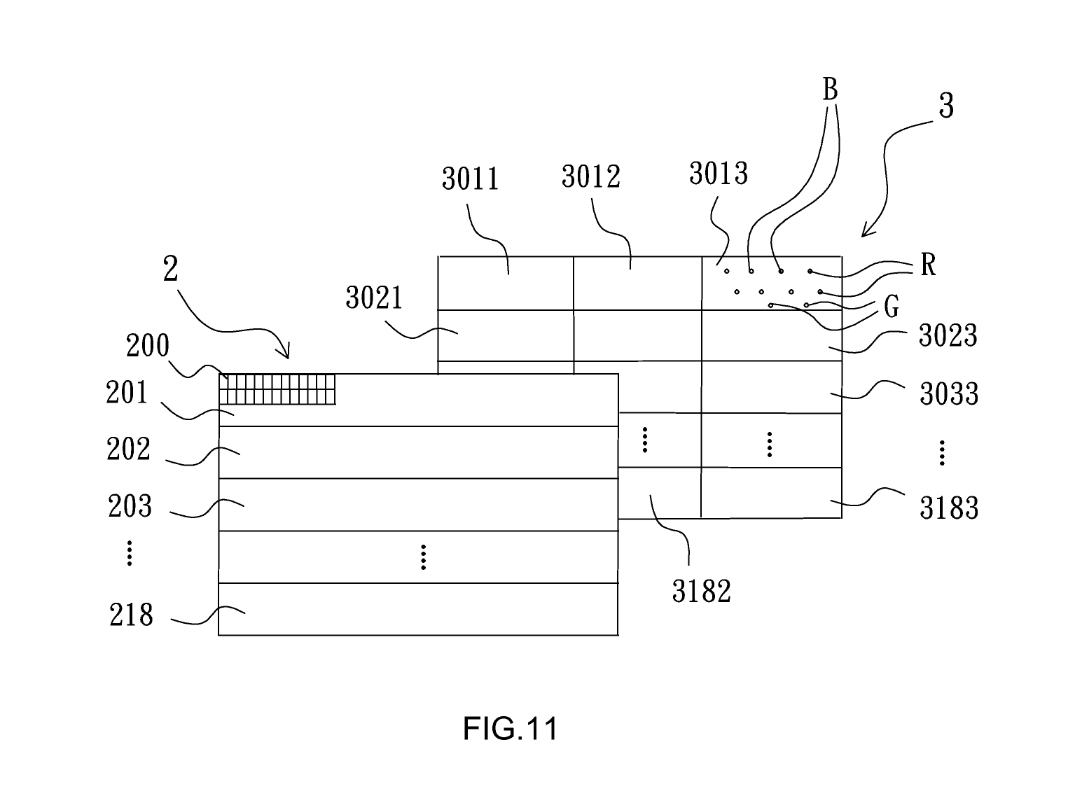

A color-filterless liquid crystal display device according to the first preferred embodiment of the invention is illustrated in FIG. 11, which comprises primarily a backlight module 3, a liquid crystal display module 2 mounted in front of the backlight module 3 and a control module 5. In this embodiment, the liquid crystal display module 2 is partitioned into 18 display sections designated as display sections 201, 202 . . . 218 in the same manner shown in FIG. 1. The display sections 201, 202 . . . 218 each includes, for example, 1920*1080/18=115,200 pixels 200. The backlight module 3 is partitioned into, for example, 18×3=54 dynamic brightness adjustment sections designated as sections 3011, 3012, 3013, 3021 . . . 3183, wherein the sections 3011, 3012, 3013 correspond to the display section 201 in the liquid crystal display module 2. Every three of the dynamic brightness adjustment sections correspond to one of the display sections, with each of the dynamic brightness adjustment sections 3011, 3012, 3013, 3021 . . . 3183 including a plurality of R, G and B LEDs. It is apparent to those skilled in the art that it is also feasible to make every one of the dynamic brightness adjustment sections in the backlight module 3 to correspond to exactly one of the display sections in the liquid crystal display module 2.

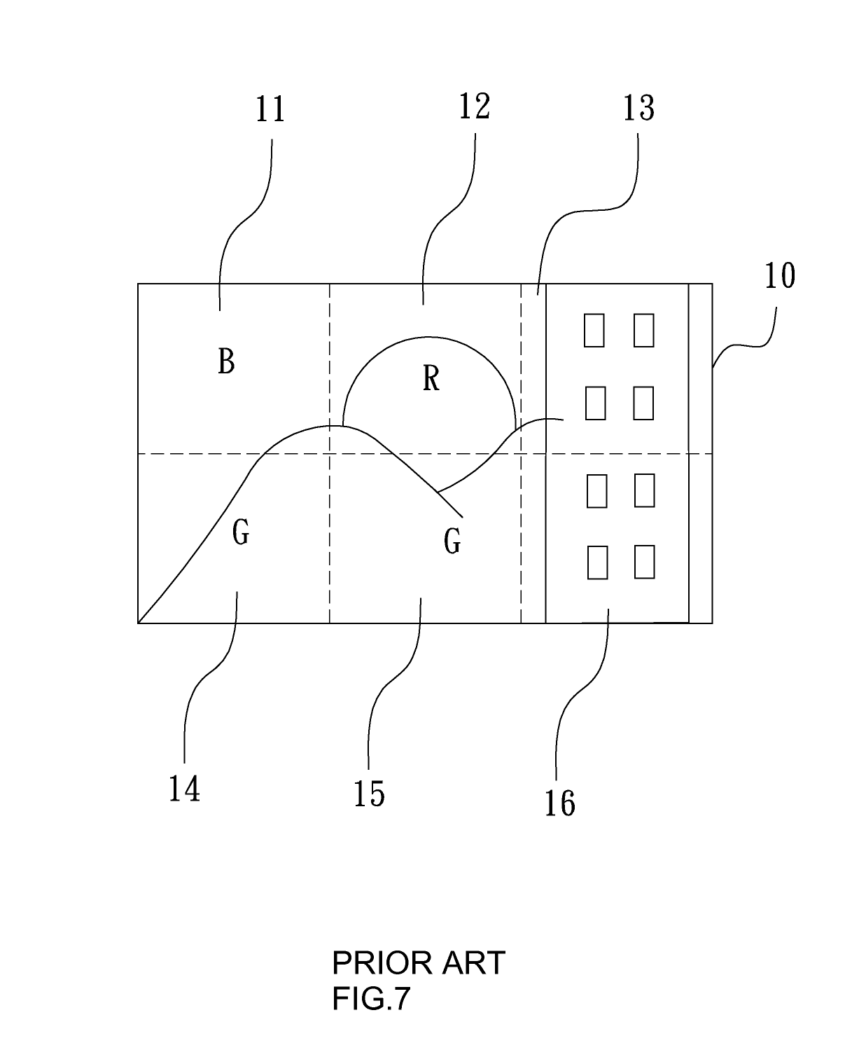

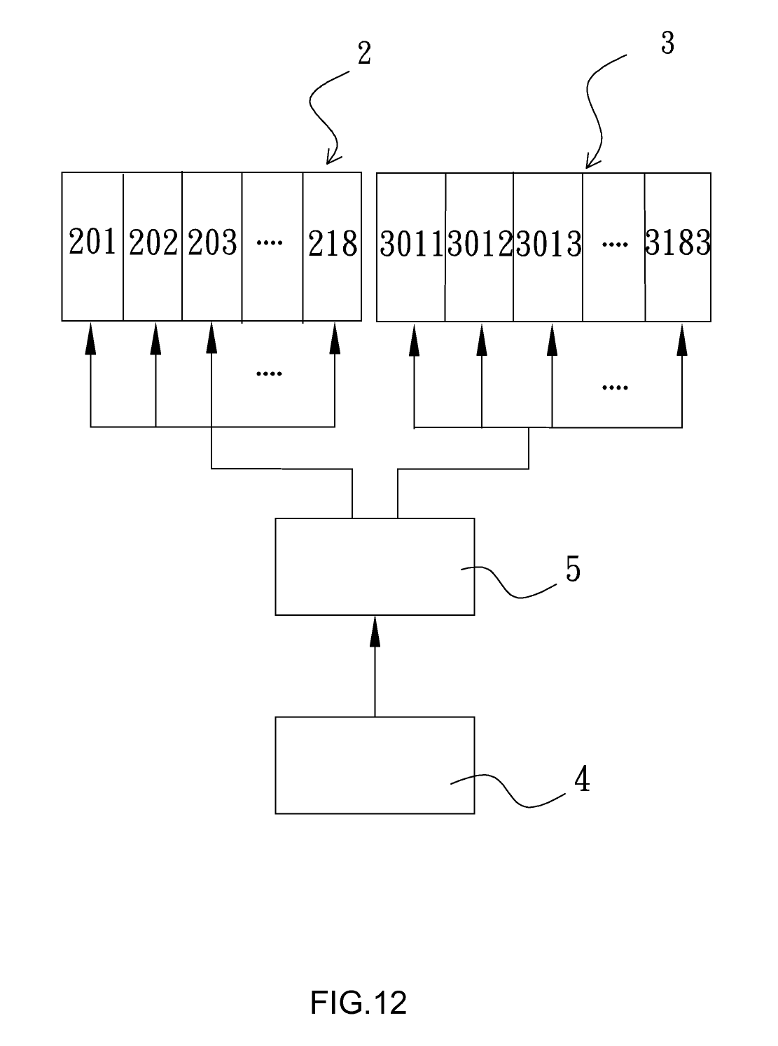

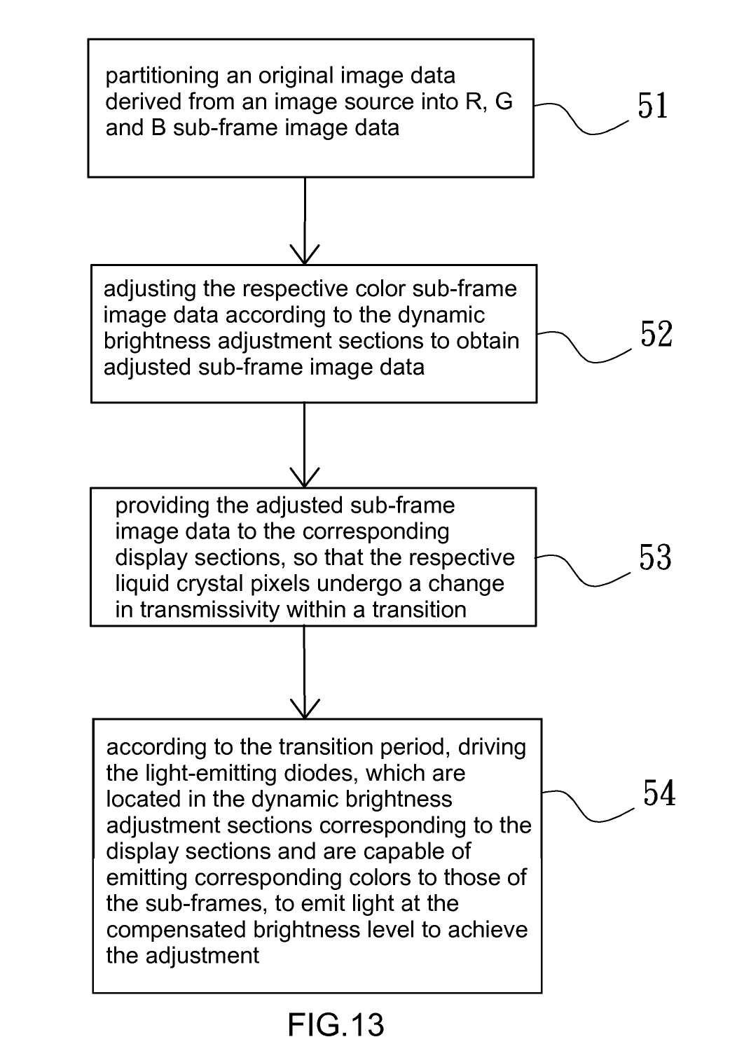

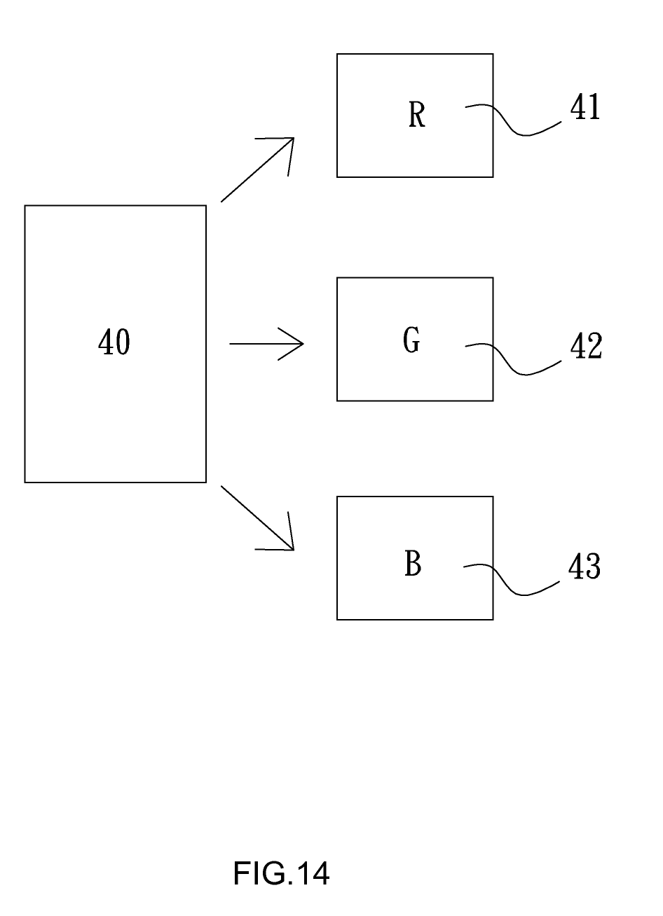

Referring together to the drawings depicted in FIGS. 12, 13 and 14, in Step 51, a frame-partitioning module 4 is provided to partition an original image data 40 derived from an image source (not shown) into red, green and blue sub-frame image data 41, 42 and 43. In Step 52, the control module 5 calculates the theoretical brightness levels of the original sub-frame image data to be provided to the corresponding liquid crystal display module 2 from the corresponding regions of the dynamic brightness adjustment sections 3011, 3012, 3013, 3021 . . . 3183, thereby determining the respective local area dimming control data for the dynamic brightness adjustment sections 3011, 3012, 3013, 3021 . . . 3183 in the backlight module 3. When the frame to be presented is the same as that shown in FIG. 7, the dynamic brightness adjustment sections 3011, 3012 are directed to the sky with blue color, the dynamic brightness adjustment section 3052 corresponds to a red-color zone directed to the sunshine and the dynamic brightness adjustment section 3013 corresponds to a grey-color zone directed to a building.

As described above, in a scanning-type LED backlight, the image signals are generated using the R-G-B color-sequential-field scanning technique. As such, the image data should be partitioned into R, G and B sub-frame image data which are then processed sequentially at different time points. By way of the “local area dimming control” technique, the respective image signals that correspond to the respective dynamic brightness adjustment sections 3011, 3012, 3013, 3021 . . . 3183 and are to be provided to the liquid crystal display module 2 are used to determine the brightness levels of the respective color LEDs located in the dynamic brightness adjustment sections 3011, 3012, 3013, 3021 . . . 3183 of the backlight module.

In the embodiment described above, the region to which the dynamic brightness adjustment section 3011 corresponds is located at a left portion of the display section 201 and employed to present the sky image in zone 11, as shown in FIG. 11. The respective primary colors of this image have brightness levels of R=0, G=0, B=255. The dynamic brightness adjustment section 3052 corresponds to a central portion of the display section 205 and is used to present the sun image in zone 12. The respective primary colors at this pixel have brightness levels of R=255, G=0, B=0. The dynamic brightness adjustment section 3013 corresponds to a region located at a right portion of the display section 201 and is used to present the image in zone 13, and the respective primary colors of this image have brightness levels of R=127, G=127, B=127.

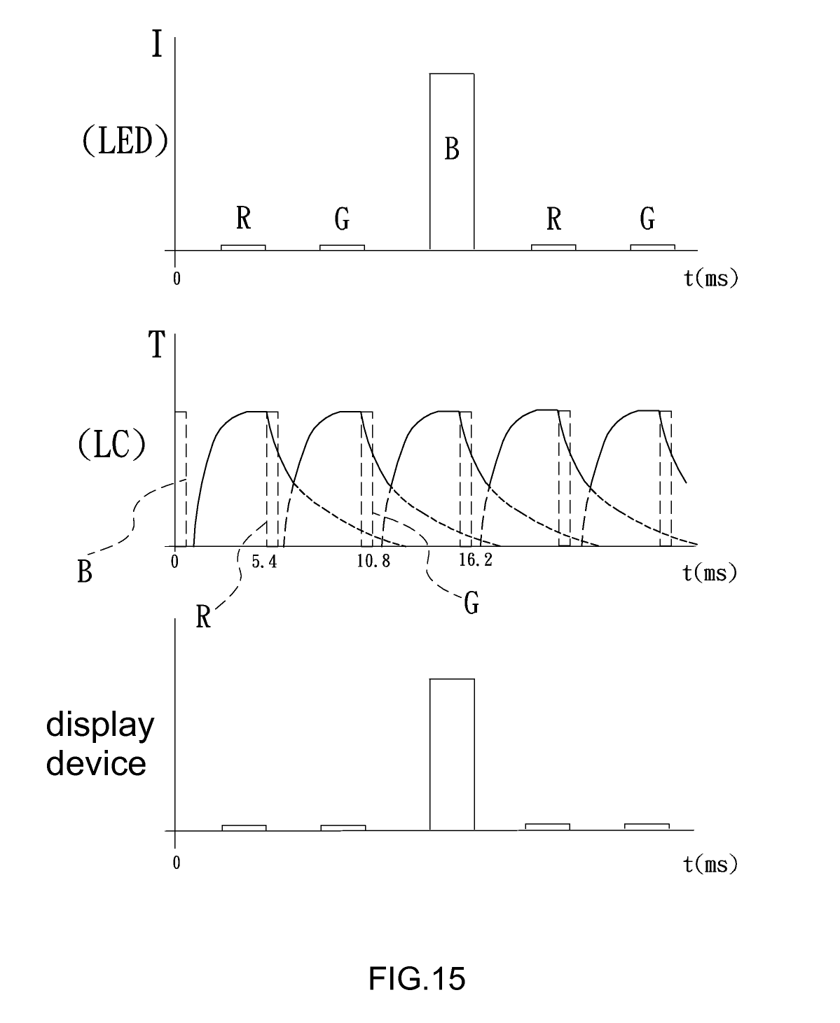

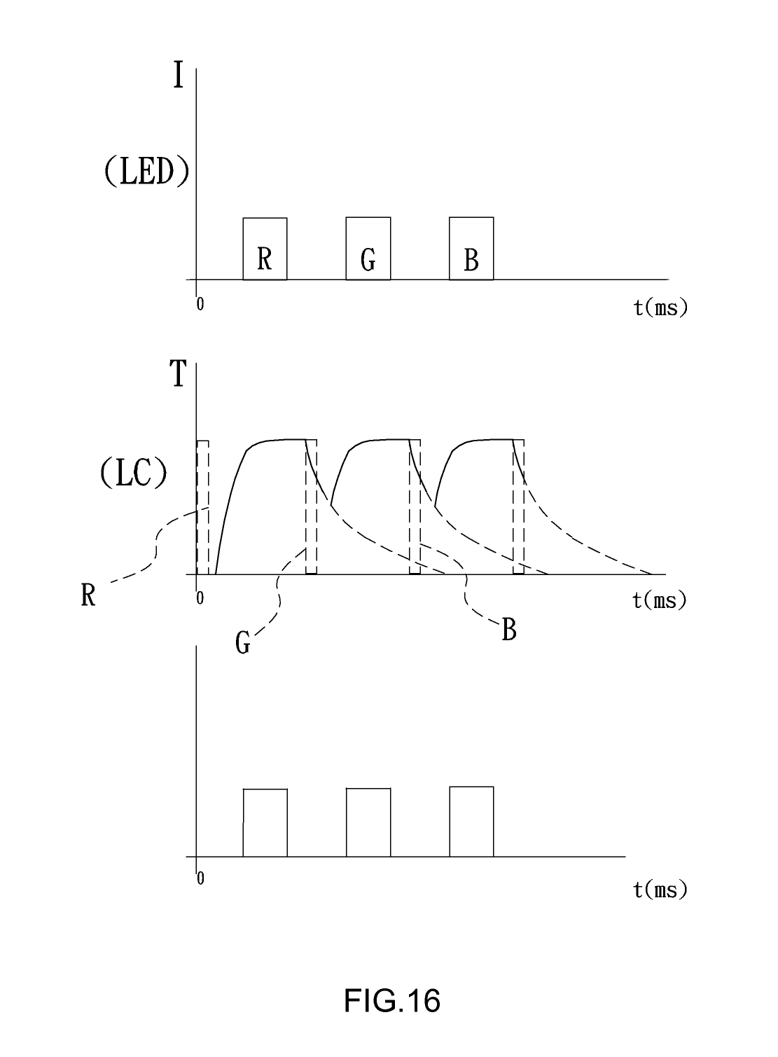

As shown in FIGS. 15 and 16, after the processing using the “local area dimming control” technique, the processed and adjusted data that demand the liquid crystals to be in the fully opened state are provided to the liquid crystal pixels in the display section 201 by a time delay ΔT from the staring points of the red, green and blue sub-frame periods. Next, in Step 53, the transmissivity of the liquid crystal pixels are changed during a transition period from t=ΔT to t=11 ΔT. Since the dynamic brightness adjustment sections 3011, 3012 present a grayscale value of blue B=255, there exists no red and green color components.

In Step 54, in order to compensate with respect to the adjusted sub-frame image data provided to the liquid crystal module, during the period from t=11 ΔT to t=18 ΔT where it is the red-light LED's turn to be lighted up, an enabling signal of grayscale 0 is given to the red-light LED located in the dynamic brightness adjustment section 3011 as a means to make the red-light LED not to emit light. The red-light LED located in the dynamic brightness adjustment section 3012 is similarly given an enabling signal of grayscale 0 and is made pure dark. The dynamic brightness adjustment section 3013 is given a signal of grayscale value of 127 to allow the red-light LED to be half lighted up.

At t=18 ΔT, the adjusted image data of the green sub-frame is provided to the display section 201 of the liquid crystal display module. Since the image data corresponding to the dynamic brightness adjustment sections 3011, 3012 and 3013 have green components at grayscale values of 0, 0 and 127, respectively, it is calculated by repeating the Step 52 that the liquid crystal pixel in the display section 201 is to be placed in the fully opened state. The adjusted image data are provided to the pixel during a period from t=18 ΔT to t=19 ΔT. In Step 53, the transmissivity of the liquid crystal pixels are changed during a transition period from t=19 ΔT to t=29 ΔT. After the transition period, the Step 54 is repeated during a period of t=29 ΔT to t=36 ΔT, in which enabling signals of grayscale values of 0, 0 and 127 are provided to the green-light LEDs located in the dynamic brightness adjustment sections 3011, 3012 and 3013, respectively, as a means to compensate with respect to the theoretical brightness level of the adjusted image data.

By the same token, during the blue sub-frame period, signals of grayscale values of 255, 0 and 127 are provided to the green-light LEDs located in the dynamic brightness adjustment sections 3011, 3012 and 3013, respectively, from the time point t=47 ΔT to t=54 ΔT. Since during the respective sub-frame periods, the LEDs located in the dynamic brightness adjustment sections 3011, 3012 are lighted up at grayscale values of (R)0, (G)0 and (B)255, respectively, the red-light LEDs and green-light LEDs are not allow to emit light. Therefore, the presented blue color will not be interfered with red or green color even if the liquid crystal molecules are not fully closed during the period other than the blue sub-frame period. In the dynamic brightness adjustment section 3013, the respective colors constituting the grey color are maintained.

The dynamic brightness adjustment section 3052 corresponds to a central portion of the display section 205. When the frame to be presented is the same as that shown in FIG. 7, assuming that the respective pixels in said section have a maximum red grayscale value of 255, and that the image data shown at the pixels have no green and blue components, and that some of the pixels adjacent to said display section present more or less green and blue components, all of the green-light LEDs and blue-light LEDs located in the dynamic brightness adjustment section 3052 must be lighted up at a grayscale value of 10. After the processing using the local area dimming control technique, the LEDs located in the dynamic brightness adjustment section 3052 are lighted up at grayscale values of (R)255, (G)10, (B)10.

Therefore, after being processed by a reverse local area dimming control technique, namely, being “adjusted” as disclosed herein, the image data are provided to the liquid crystal pixels in a scanning manner in the following sequence: the liquid crystal molecules being placed in a fully opened state (255) during the red sub-frame period, the liquid crystal molecules being placed in a fully closed state (0) during the green sub-frame period and then the liquid crystal molecules being placed in a fully closed state (0) during the blue sub-frame period. Given the limitation that the time which it must take to convert the liquid crystal molecules from the fully opened state to the fully closed state is in reality longer than a sub-frame time for a given primary color, the liquid crystal molecules have not fully closed during the green sub-frame period. Owing to the invention, even if the liquid crystal molecules are merely closed to an extent that has a transmissivity of 30%, the LEDs mounted behind are lighted up at the compensated brightness level for the adjustment, namely, at a brightness of grayscale value of only 10. As a result, the mount of green light leaking from the display is at grayscale level of 3, which is so small that it can hardly be perceived by viewers. As compared to the prior art where the amount of light leak can be at a level up to a grayscale value of 70, the improvement achieved by the invention is significant.

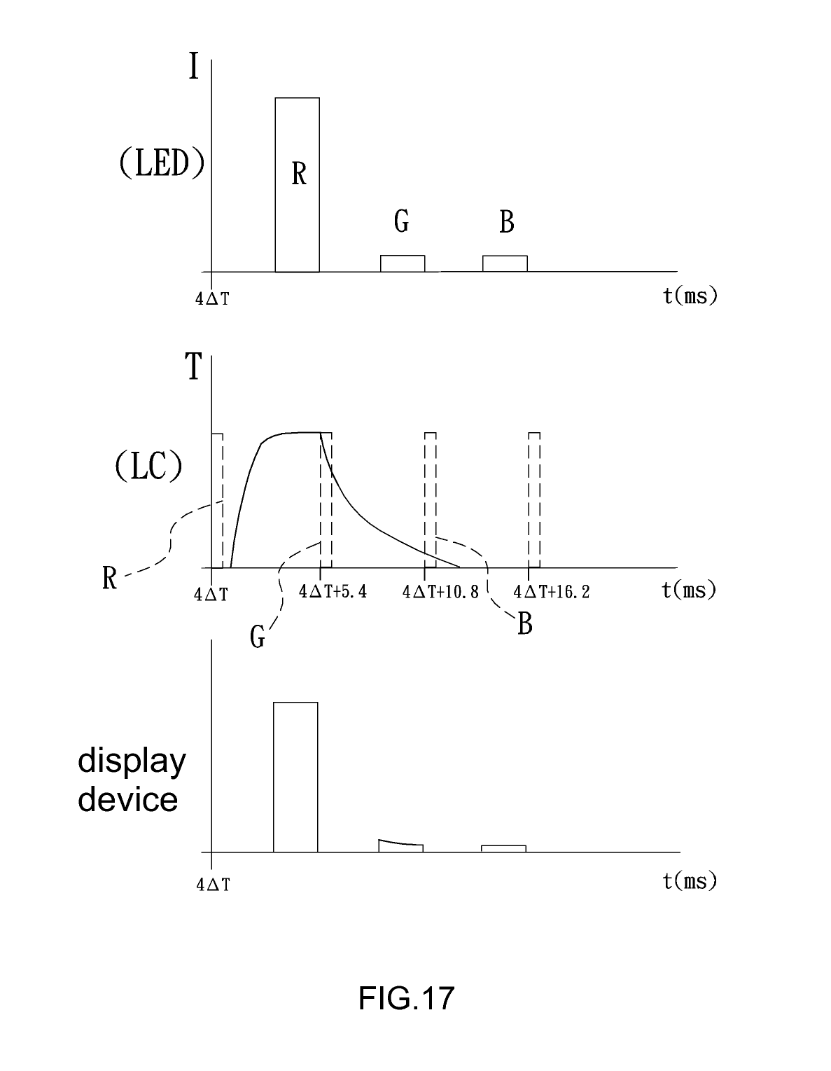

In addition, the image data of respective sub-frames are displayed in the display sections in such a sequential manner that the respective display sections sequentially present the image by a time delay of a ΔT (3 ms). Therefore, the respective timings for the display sections 201 and 205 to receive the image data of red sub-frames are separated by a time delay of 4 ΔT. As shown in FIG. 17, the period that the LEDs are lighted up in the dynamic brightness adjustment section 3052, the period that the transmissivity of the liquid crystal molecules in the display section 205 is being changed and the period that the display device is displaying the image all take place 4 ΔT later than the counterpart periods shown in FIGS. 15 and 16.

It can be readily appreciated by those skilled in the art that the sections described above are merely a simplified model. For a liquid crystal display module provided with a total of 1920*1080 pixels, the pixels can be partitioned vertically into an even number of display sections, such as N=18. Each of the display sections contains 60 scan lines, and all of the display sections are arranged across the entire picture in the horizontal direction. The backlight module can be partitioned in such a manner that a single dynamic brightness adjustment section is arranged correspondingly to a single display section. As an alternative, the backlight module can be further partitioned into rows along the horizontal direction, so that each row includes M=32 dynamic brightness adjustment sections commonly responding to a single display section. Therefore, there are a total of M×N dynamic brightness adjustment sections, each corresponding to exactly 60×60 pixels in the liquid crystal display module. Each of the dynamic brightness adjustment sections is independently provided with a light source composed of LEDs of at least three primary colors, so that the chromaticity and brightness of the respective dynamic brightness adjustment sections can be controlled independently.

According to the invention, the local area dimming control technique described above is used herein in combination with the scanning-type LED backlight technique. The local area dimming control technique contemplates partitioning a backlight module into a two-dimensional array of M×N sections. From the color values of an image to be presented in a liquid crystal display module partitioned into the M×N sections, an approximate brightness value of the image is deduced by using the local area dimming control technique. The approximate brightness value is then used to control the brightness levels of the corresponding R, G and B LEDs located in the respective dynamic brightness adjustment sections, and the corresponding liquid crystal display sections are adjusted reversely, so as to display the image with high quality. For example, in the case where an image is presented in a certain region at a half brightness level, the brightness of the LED backlight deduced using the idea of “local area dimming control” is at a brightness level of 50%. The corresponding liquid crystals are therefore placed in a 100% opened state, instead of the original 50% opened state, so as to maintain the brightness of the original image. According to the invention, the image data of respective sub-frames that are reversely adjusted and provided to the liquid crystal display module are referred to as the “adjusted” image data of respective sub-frames, whereas a control means, such as an enabling signal, that is provided to the backlight module in a later time sequence to thereby light up LEDs of respective colors is defined herein as a means to enable the LEDs to emit light at the compensated brightness level for the adjustment.

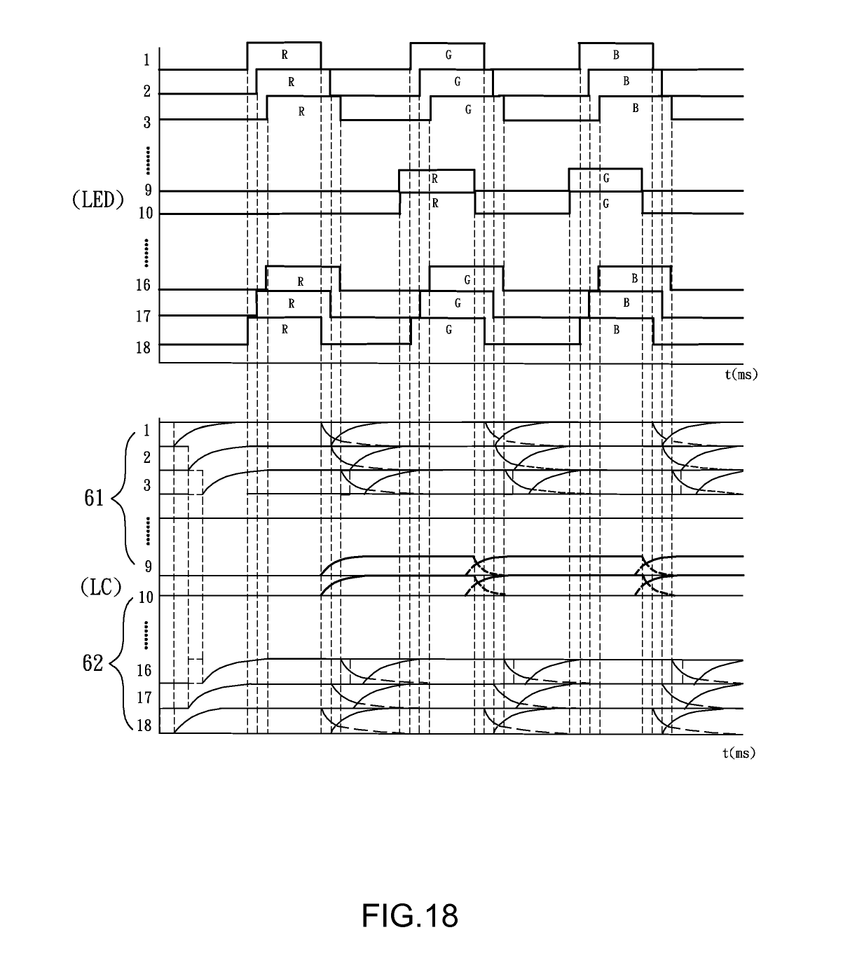

In addition, as disclosed in R.O.C. Patent Application No. 095106998, which is owned by the applicant and entitled “LCD Device and Scanning Method Thereof,” the scan zone described above is not limited to be single in number, and the liquid crystal display module can be partitioned into two or more scan zones. According to the second preferred embodiment of the invention as shown in FIG. 18, the 18 display sections illustrated in FIG. 1 can be further grouped into a upper scan zone 61 and a lower scan zone 62. The sections 1-9 in the upper scan zone 61 are provided with image data of respective color sub-frames following the scanning order described above, while the lower scan zone 62 is scanned in a reverse direction from the section 18 to the section 10. By this way, the frame processing speed of the display device is doubled up.

In comparison with the prior art, the invention is capable of realizing a color-filterless liquid crystal display device which is effective to avoid the emitted light from being absorbed by a color filter and converted to useless heat energy, thereby meeting the global trend towards energy saving and carbon emission reduction. The color-filterless liquid crystal display device according to the invention is particularly useful in significantly reducing the improper mixing of colors and can therefore present a broad gamut and an increased color diversion with close resemblance to those derived from the RGB LEDs mounted in the backlight module. The display device according to the invention may be further partitioned to have multiple scan zones, so that the image displaying speed is doubled up to meet the recent trend in this regard.

While the invention has been described with reference to the preferred embodiments above, it should be recognized that the preferred embodiments are given for the purpose of illustration only and are not intended to limit the scope of the present invention and that various modifications and changes, which will be apparent to those skilled in the relevant art, may be made without departing from the spirit and scope of the invention.

What is claimed is:

1. A color-filterless liquid crystal display device for displaying a frame within a predetermined display period, the frame being partitioned into image data of at least three color sub-frames, the display device comprising:
a liquid crystal display module including at least one scan zone, the at least one scan zone being partitioned into a plurality of display sections, wherein each of the display sections includes a plurality of pixels;
a backlight module partitioned into a plurality of dynamic brightness adjustment sections in such a manner that every one of the display sections is arranged to correspond to at least one of the dynamic brightness adjustment sections, wherein each of the dynamic brightness adjustment sections comprises light emitting diodes of at least three colors, with each of the colors being presented by at least one of the light emitting diodes, and wherein the light emitting diodes are lighted up sequentially in a color-by-color manner; and
a control module for adjusting the image data of the sub-frames according to the dynamic brightness adjustment sections to obtain adjusted image data of the sub-frames, and for providing the adjusted image data of one of the sub-frames to the corresponding pixels located in one of the display sections, so that the pixels are driven to undergo a change in transmissivity within a transition period according to the adjusted image data, and for driving, according to the transition period, at least one of the light-emitting diodes of at least three colors, which is located in the dynamic brightness adjustment section corresponding to the display section and is capable of emitting light with a color corresponding to the color of the sub-frame, to emit light at the compensated brightness level for the adjustment.

2. The liquid crystal display device according to claim 1, wherein the display sections of the at least one scan zone are arranged in parallel with one another along a longitudinal direction, and the adjusted image data of the sub-frames are provided sequentially in an order of the arrangement to the pixels located in the corresponding display sections.

3. The liquid crystal display device according to claim 1, wherein the display sections of the at least one scan zone are arranged in parallel with one another along a longitudinal direction, and the adjusted image data of the sub-frames are provided to the pixels located in the corresponding display sections at different time points.

4. The liquid crystal display device according to claim 2, comprising a plurality of scan zones arranged in parallel with one another along the longitudinal direction.

5. The liquid crystal display device according to claim 3, comprising a plurality of scan zones arranged in parallel with one another along the longitudinal direction.

6. The liquid crystal display device according to claim 1, further comprising a frame-partitioning module for partitioning an original image data of the frame into image data of at least three color sub-frames.

7. The liquid crystal display device according to claim 1, wherein the time necessary for converting liquid crystal molecules from a fully opened state to a fully closed state is longer than a sub-frame time for displaying a sub-frame.

8. A displaying method of a color-filterless liquid crystal display device, wherein the liquid crystal display device is used for displaying a frame within a predetermined display period and the frame is partitioned into image data of at least three color sub-frames, and wherein the display device comprises a liquid crystal display module including at least one scan zone, the at least one scan zone being partitioned into a plurality of display sections; and a backlight module partitioned into a plurality of dynamic brightness adjustment sections in such a manner that every one of the display sections is arranged to correspond to at least one of the dynamic brightness adjustment sections, and wherein each of the display sections includes a plurality of pixels, and each of the dynamic brightness adjustment sections comprises light emitting diodes of at least three colors, with each of the colors being presented by at least one of the light emitting diodes, and wherein the light emitting diodes are lighted up sequentially in a color-by-color manner, the method comprising the steps of:
a) adjusting the image data of the respective color sub-frames according to the dynamic brightness adjustment sections to obtain adjusted image data of the sub-frames;
b) providing the adjusted image data of the sub-frames to every one of the corresponding pixels located in one of the display sections of the at least one scan zone, and driving the pixels to undergo a change in transmissivity within a transition period according to the adjusted image data; and
c) according to the transition period, driving at least one of the light-emitting diodes of at least three colors, which is located in the dynamic brightness adjustment section corresponding to the display section and is capable of emitting light with a color corresponding to the color of the sub-frame, to emit light at the compensated brightness level for the adjustment.

9. The displaying method according to claim 8, further comprising, before the step a), a step d) of partitioning an original image data corresponding to the frame into the image data of at least three color sub-frames.
